(19) United States
(12) Patent Application Publication
(10) Pub. No.: US 2008/0057909 A1
(43) Pub. Date: Mar. 6, 2008

(54) Method and apparatus for restoring phonebook in wireless terminal

(75) Inventor: Jun-Chul Kang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/651,602

(22) Filed: Jan. 10, 2007

(30) Foreign Application Priority Data
Aug. 30, 2006 (KR) 82947/2006

(51) Int. Cl. H04L 12/58

(52) U.S. Cl. 455/412.1

(57) ABSTRACT

A apparatus and method are provided for the management of a phonebook in a wireless terminal, the method including the steps of changing a restoration bit for a phonebook to a bit value corresponding to phonebook deletion when deletion of the phonebook is requested, and deleting the phonebook, the restoration bit for which having been changed to the bit value corresponding to phonebook deletion, from a phonebook list, and changing a restoration bit for a phonebook to a bit value corresponding to phonebook registration when restoration of the phonebook is requested, and then restoring the phonebook, the restoration bit for which having been changed to the bit value corresponding to phonebook registration, to a phonebook list.

### CROSS-REFERENCE TO RELATED APPLICATION

This application claims the benefit under 35 U.S.C. 119(a) of Korean Patent Application No. 10-2006-0082947, entitled “Method And Apparatus For Restoring Phonebook In Wireless Terminal” filed Aug. 30, 2006 in the Korean Intellectual Property Office, the entire disclosure of which is incorporated herein by reference.

### BACKGROUND OF THE INVENTION

1. Field of the Invention

The present invention relates to a wireless terminal. More particularly, the present invention relates to a method and apparatus for deleting a phonebook and restoring the deleted phonebook in a wireless terminal.

2. Description of the Related Art

As wireless terminals become more widely used, users now prefer using a wireless terminal for communication rather than using a wired terminal virtually everywhere, including at their homes. Communication using a wireless terminal typically requires the input of a counterpart's phone number, so most users store the phone numbers of communication counterparts in the phonebook lists of wireless terminals. Therefore, it is often necessary in communications using a wireless terminal to use such a phonebook.

Consequently, as the user uses a wireless terminal more and more, the frequency of the use of the phonebook also increases. However, if the users deliberately or mistakenly delete a phonebook, most users will then experience a great amount of inconvenience due to the fact that they may not remember a deleted communication counterpart's phone number.

Accordingly, a need exists for a system and method for managing the deletion and restoration of mobile terminal phonebooks and similar information.

### SUMMARY OF THE INVENTION

Accordingly, embodiments of the present invention have been provided to substantially address the above and other problems, and provide a method and apparatus for the management of a phonebook, which can delete a phonebook and can easily restore the deleted phonebook.

To this end, in accordance with one aspect of embodiments of the present invention, a method for the management of a phonebook in a wireless terminal is provided, comprising changing a restoration bit for a phonebook to a bit value corresponding to phonebook deletion when deletion of the phonebook is requested, and then deleting the phonebook, the restoration bit for which having been changed to the bit value corresponding to phonebook deletion, from a phonebook list.

In accordance with another aspect of embodiments of the present invention, a method for the management of a phonebook in a wireless terminal is provided, comprising changing a restoration bit for a phonebook to a bit value corresponding to phonebook registration when restoration of the phonebook is requested, and then restoring the phonebook, the restoration bit for which having been changed to the bit value corresponding to phonebook registration, to a phonebook list.

In accordance with another aspect of embodiments of the present invention, an apparatus for the management of a phonebook in a wireless terminal is provided, comprising a memory for storing at least one phonebook including a restoration bit, and a controller for changing a restoration bit for a phonebook to a bit value corresponding to phonebook deletion when deletion of the phonebook is requested, and deleting the phonebook requested to be deleted from a phonebook list, and changing a restoration bit for a phonebook to a bit value corresponding to phonebook registration when restoration of the phonebook is requested, and restoring the phonebook requested to be restored to a phonebook list.

### BRIEF DESCRIPTION OF THE DRAWINGS

The above and other objects, features and advantages of embodiments of the present invention will become more apparent from the following detailed description taken in conjunction with the accompanying drawings, in which:

FIG. 1 is a block diagram illustrating construction of an exemplary wireless terminal according to an embodiment of the present invention;

FIG. 2 is a flowchart illustrating an exemplary procedure of deleting and restoring a phonebook according to an embodiment of the present invention; and

FIG. 3 is a flowchart illustrating an exemplary procedure of storing a phonebook according to an embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described with reference to the accompanying drawings.

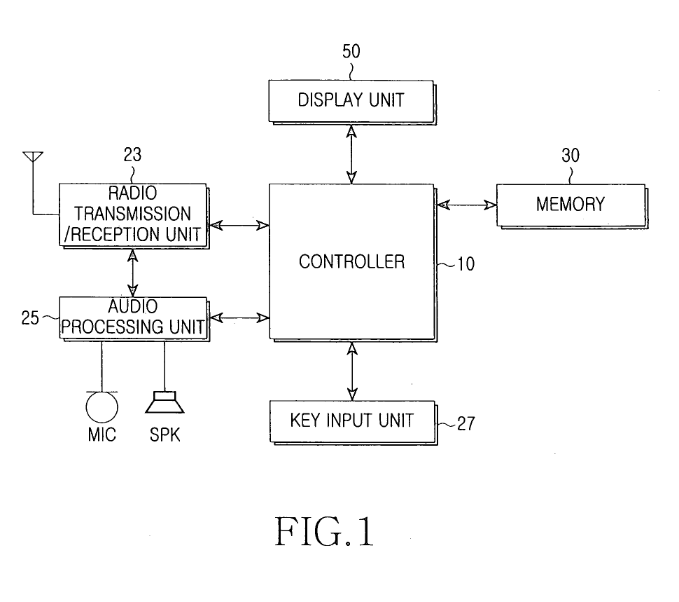

FIG. 1 is a block diagram illustrating construction of an exemplary wireless terminal according to an embodiment of the present invention. The wireless terminal can comprise a controller 10, a radio transmission/reception unit 23, an audio processing unit 25, a key input unit 27, a memory 30 and a display unit 50. The wireless terminal can further comprise a microphone MIC and a speaker SPK.

The radio transmission/reception unit 23 includes an RF unit and a modem. The RF unit includes an RF transmitter and an RF receiver, in which the RF transmitter up-converts and amplifies the frequency of a signal to be transmitted, and the RF receiver low-noise amplifies a received signal and down-converts the frequency of the received signal. The modem includes a transmitter for encoding and modulating the signal to be transmitted, and a receiver for demodulating and decoding the received signal.

The audio processing unit 25 can include a codec which contains a data codec and an audio codec. The data codec processes packet data and the like, and the audio codec processes an audio signal such as a voice and multimedia file. The audio processing unit 25 converts a digital audio signal received from the modem of the radio transmission/reception unit 23 into an analog signal by means of the audio codec and transmits the converted analog audio signal to the speaker SPK, thereby reproducing the converted analog signal. Also, the audio processing unit 25 converts an analog audio signal generated from the microphone MIC into a digital audio signal by means of the audio codec, and transmits the converted digital audio signal to the modem of the radio transmission/reception unit 23. The codec can be separately constructed, or can be included in the controller 10.

The key input unit 27 includes keys for inputting numeral and character information, and includes function keys for setting various functions.

The memory 30 can include a program memory and a data memory. The program memory stores programs for controlling general operations of the wireless terminal. Also, according to an embodiment of the present invention, the memory 30 stores at least one phonebook. A schematic structure of an exemplary phonebook according to an embodiment of the present invention, and a registration number associated with the phonebook, are shown by way of example in Table 1 below.

In Table 1, registration information of communication counterparts is stored as an item “storage contents”, and includes various information, such as names, telephone numbers, birthdays, e-mail addresses, and so forth. The registration number is called an “address of a phonebook”, and is used for abbreviated dialing, generally through a long key function. A restoration bit changes to a bit value (e.g., zero) corresponding to phonebook deletion when the phonebook has been deleted, and changes to a bit value (e.g., one) corresponding to phonebook registration when the phonebook has been registered. According to another embodiment of the present invention, a phonebook can be constructed with only the items “storage contents” and “registration number”. In this case, a restoration bit does not exist in the phonebook when the phonebook is registered, but the restoration bit is created and added to the phonebook when the phonebook is deleted.

TABLE 1

| | | |
|---|---|---|
| Registration Number | Restoration Bit | Storage Contents |

The display unit 50 can be constructed with a liquid crystal display (LCD) and/or organic light emitting diodes (OLED), and can display various display information generated in the wireless terminal. In this case, when the LCD and/or OLED is provided as a touch screen apparatus, the display unit 50 can also serve as an input section for controlling the wireless terminal, together with or in place of the key input unit 27. Also, according to embodiments of the present invention, the display unit 50 can display a restoration menu so that the user can easily find a deleted phonebook that the user desires to be restored, when restoration of the deleted phonebook has been requested.

The controller 10 controls operations or switchover to a driving mode of the wireless terminal. According to an embodiment of the present invention, when the user request the deletion of a phonebook, the controller 10 changes a corresponding restoration bit to a bit value (e.g., zero) corresponding to phonebook deletion so that the phonebook can be deleted from the phonebook list, preferably without deleting data stored in the phonebook. In addition, when the user requests the restoration of a deleted phonebook or the storage of a new phonebook, the controller 10 changes the restoration bit for a corresponding phonebook to a bit value corresponding to phonebook registration so that the corresponding phonebook can be registered in the phonebook list.

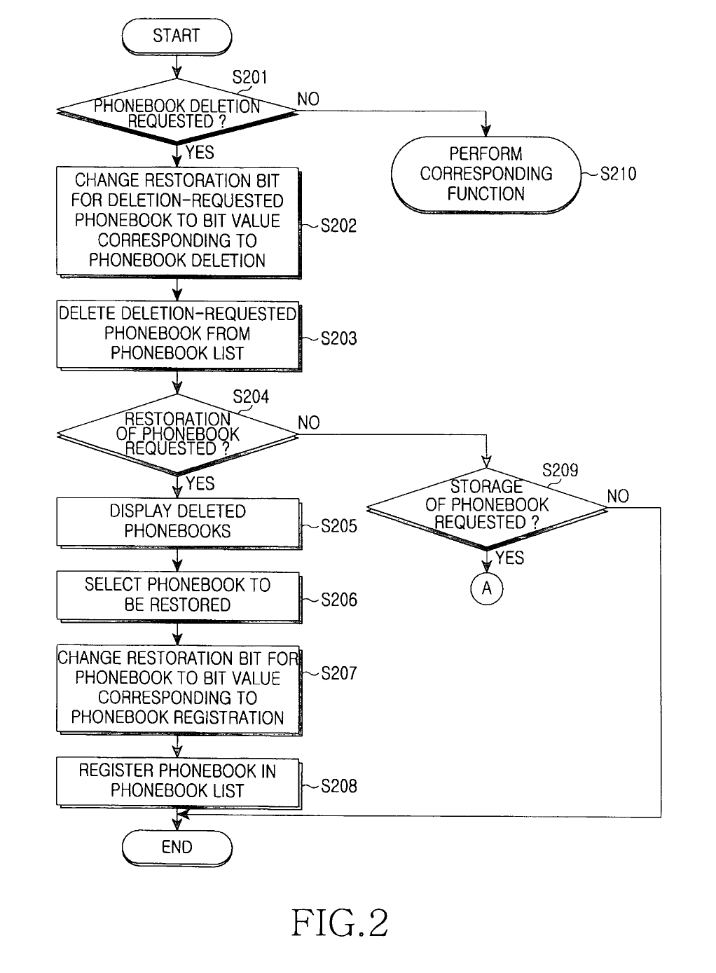

FIG. 2 is a flowchart illustrating an exemplary procedure of deleting and restoring a phonebook according to an exemplary embodiment of the present invention.

When the user requests the deletion of a phonebook in step S201, the controller 10 changes a restoration bit for the deletion-requested phonebook to a bit value corresponding to phonebook deletion in step S202, and deletes the deletion-requested phonebook from the phonebook list in step S203.

That is, when the user selects a phonebook to be deleted from the phonebook list and requests the deletion of the selected phonebook, the controller 10 changes the restoration bit for the deletion-requested phonebook to a bit value (e.g., zero) corresponding to phonebook deletion. The phonebook, the restoration bit for which having been changed to a bit value corresponding to deletion as described above, is then deleted from the phonebook list. However, when a phonebook is deleted from the phonebook list according to an embodiment of the present invention, the contents stored in the phonebook are preferably not deleted or deletion is delayed, and only the restoration bit for the phonebook is changed to a bit value corresponding to phonebook deletion.

Thereafter, when the user requests the restoration of a deleted phonebook in step S204, the controller 10 displays phonebooks deleted from the phonebook list in step S205, and receives a selection of a phonebook to be restored from the user in step S206.

According to an embodiment of the present invention, when the user requests the restoration of a phonebook, the deleted phonebooks are displayed so that a phonebook to be restored can be selected from the deleted phonebooks. However, the controller 10 can provide the user with a function of restoring all deleted phonebooks, through a separate menu.

In addition, upon displaying phonebooks deleted from the phonebook list, the controller 10 can display the contents stored in the deleted phonebooks together with the deleted phonebooks so that the user can rapidly identify and find a desired phonebook to be restored. In this case, a communication counterpart's name or address, which has been recorded in a phonebook, can be displayed as representative data of the phonebook to be displayed for the user, or all of the contents stored in a restoration-requested phonebook can be displayed as requested by the user.

When a phonebook to be restored is selected in steps S205 and S206, the controller 10 changes the restoration bit for the selected phonebook to a bit value corresponding to phonebook registration in step S207, so as to register the selected phonebook in the phonebook list in step S208.

That is, the controller 10 changes the restoration bit for the phonebook selected to be restored to a bit value (e.g., one) corresponding to phonebook registration, so as to again register the phonebook which had been deleted from the phonebook list.

If the user does not request the restoration of a deleted phonebook in step S204, the user can request the storage of a new phonebook in step S209. If the user requests the storage of a new phonebook in step S209, the method proceeds to step S302 described in greater detail below.

Further, if the user does not request the deletion of a phonebook in step S201, the controller 10 simply performs a corresponding function as commanded in step S210.

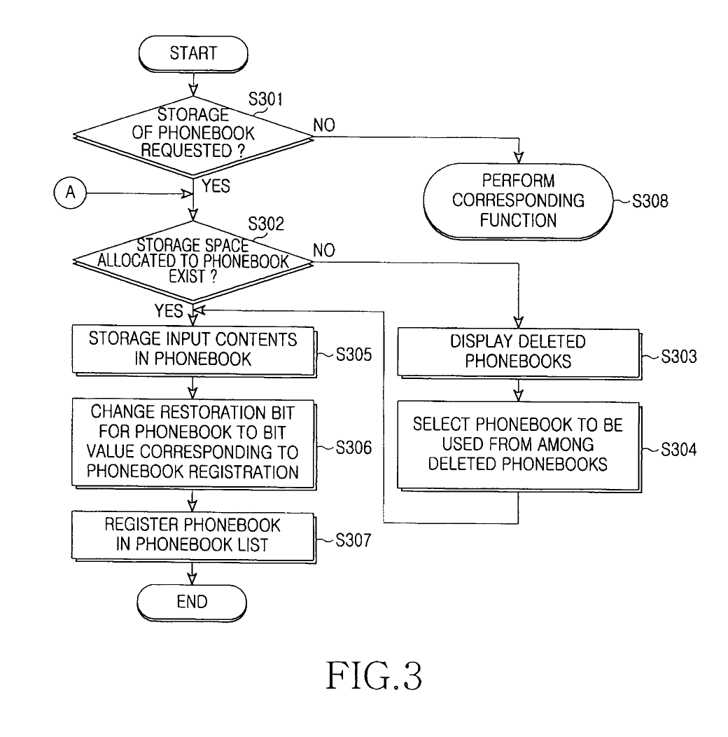

FIG. 3 is a flowchart illustrating an exemplary procedure of storing a phonebook according to an embodiment of the present invention.

When the user requests storage of a phonebook in step S301, the controller 10 determines if there is storage space to be allocated for the phonebook in step S302.

Generally, the storage space which can be allocated for phonebooks in a wireless terminal is limited. For example, registration numbers of 1 to 100 and phonebooks corresponding to each registration number can provide a total of 100 phonebooks. Therefore, when 20 phonebooks of the 100 phonebooks have been deleted after registration and the remaining 80 phonebooks have all been used, there are no empty phonebooks remaining to store any further data in the wireless terminal, even if the user requests new data to be recorded in a phonebook. This is because when a phonebook is deleted according to an embodiment of the present invention, the phonebook is deleted from only the phonebook list, and the data of the phonebook is not deleted. Therefore, when the user requests to record data for a phonebook, the controller 10 determines if there is space to store the storage-requested phonebook by checking the storage space allocated for the phonebook. When it is determined in step S302 that there is no storage space to be allocated, the controller 10 displays deleted phonebooks in step S303, and receives a selection of a phonebook to be recorded therein from among the deleted phonebooks from the user in step S304.

That is, when it is determined that there is no space in which a phonebook can be stored, the controller 10 determines if there are deleted phonebooks, and displays deleted phonebooks to the user when there are deleted phonebooks. In this case, the controller 10 preferably displays the contents of data stored in the deleted phonebooks to the user. With reference to the contents of data displayed as described above, the user can select a phonebook, which is unlikely to be restored in the future, from among the deleted phonebooks. For example, when the user determines that it is not probable that a phonebook for a person (i.e., “Hong Gil Dong”), who has previously been deleted, will be restored in the future, the user selects the phonebook for the person (i.e., “Hong Gil Dong”) so that data stored in the phonebook for the person can be deleted and new data can be recorded in the corresponding storage space.

The controller 10 then records data input by the user in a corresponding phonebook in step S305, changes the restoration bit for the phonebook to a bit value corresponding to phonebook registration in step S306, and registers the phonebook in the phonebook list in step S307.

When it is determined as a result of step S302 that there is enough storage space to be allocated to a phonebook, or when a phonebook on which new contents will be stored (i.e., will be overwritten) is selected from among the deleted phonebooks in steps S303 and S304, the controller 10 receives the contents to be stored from the user and stores the received contents in a corresponding phonebook. Thereafter, when the controller 10 completes the storage of the contents input from the user, the controller 10 changes the restoration bit for the phonebook to a bit value corresponding to phonebook registration and registers the phonebook in the phonebook list.

If the user does not request the storage of a phonebook in step S301, the controller 10 simply performs a corresponding function as commanded in step S308.

The method and apparatus for restoring a deleted phonebook after deleting the phonebook according to embodiments of the present invention provide a number of benefits. For example, when a phonebook has been deleted, the deleted phonebook is no longer visually shown to a user as in general deleting methods, yet the deleted phonebook can be easily restored later.

While the present invention has been shown and described with reference to certain exemplary embodiments thereof, it will be understood by those skilled in the art that various changes in form and detail may be made therein without departing from the spirit and scope of the invention as defined by the appended claims. Accordingly, the scope of the invention is not to be limited by the above embodiments but by the claims and the equivalents thereof.

What is claimed is:

1. A method for management of a phonebook in a wireless terminal, the method comprising:
changing a restoration bit for a phonebook to a bit value corresponding to phonebook deletion when deletion of the phonebook is requested; and
deleting the phonebook from a phonebook list.

2. The method as claimed in claim 1, further comprising:
changing a restoration bit for a phonebook to a bit value corresponding to phonebook registration when restoration of the phonebook is requested; and
registering the phonebook to the phonebook list.

3. The method as claimed in claim 1, further comprising:
displaying at least one phonebook deleted from the phonebook list when a phonebook restoration is requested, and receiving a selection command designating a phonebook to be restored;
changing a restoration bit for the phonebook selected to be restored to a bit value corresponding to phonebook registration; and
registering the phonebook in the phonebook list.

4. The method as claimed in claim 1, further comprising:
receiving data corresponding to contents to be stored and storing the data in the phonebook, when storage of the phonebook is requested;
changing a restoration bit for the phonebook to a bit value corresponding to phonebook registration; and
registering the phonebook in the phonebook list.

5. The method as claimed in claim 1, further comprising:
checking a storage space allocated to the phonebook list when storage of the phonebook is requested, and displaying phonebooks deleted from the phonebook list when there is substantially no empty storage space;
receiving data corresponding to contents to be stored, and storing the data in a phonebook selected from the displayed deleted phonebooks;
changing a restoration bit for the phonebook to a bit value corresponding to phonebook registration; and
registering the phonebook in the phonebook list.

6. The method as claimed in claim 1, further comprising, when a phonebook is deleted from the phonebook list, maintaining the contents stored in the phonebook.

7. An apparatus for management of a phonebook in a wireless terminal, the apparatus comprising:
a memory for storing at least one phonebook including a restoration bit; and
a controller for changing the restoration bit for the phonebook to a bit value corresponding to phonebook deletion when deletion of the phonebook is requested, and deleting the phonebook from a phonebook list.

8. The apparatus as claimed in claim 7, wherein, when the controller senses a restoration request of a phonebook deleted from the phonebook list, the controller is configured to change a restoration bit of the phonebook requested to be restored to a bit value corresponding to phonebook registration, and register the restoration-requested phonebook in the phonebook list.

9. The apparatus as claimed in claim 7, wherein, when storage of the phonebook is requested, the controller is configured to:
receive data corresponding to contents of the storage-requested phonebook and store the data in the phonebook;
change a restoration bit for the phonebook to a bit value corresponding to phonebook registration; and
register the phonebook in the phonebook list.

10. The apparatus as claimed in claim 7, wherein the controller is configured to check a storage space, which has been allocated to the phonebook list, when storage of the phonebook is requested.

11. The apparatus as claimed in claim 10, wherein, when there is an empty storage space, the controller is configured to:
receive data corresponding to contents of the storage-requested phonebook and store the data in the phonebook;
change a restoration bit for the phonebook to a bit value corresponding to phonebook registration; and
register the phonebook in the phonebook list.

12. The apparatus as claimed in claim 10, wherein, when there is no empty storage space, the controller is configured to:
display the deleted phonebooks;
receive data corresponding to contents of a phonebook selected from among the deleted phonebooks and store the data in the phonebook;
change a restoration bit for the selected phonebook to a bit value corresponding to phonebook registration; and
register the phonebook, the data of which has been stored, in the phonebook list.

13. A method for management of a phonebook in a wireless terminal, the method comprising:
identifying at least one phonebook of the wireless terminal by a restoration bit; and
changing the restoration bit for the phonebook in response to a user command, wherein the restoration bit determines a deletion and registration status of the phone book.

14. The method as claimed in claim 13, further comprising:
changing the restoration bit for the phonebook to a bit value corresponding to phonebook deletion when deletion of the phonebook is commanded; and
deleting the phonebook from a phonebook list.

15. The method as claimed in claim 14, further comprising, when a phonebook is deleted from the phonebook list, maintaining the contents stored in the phonebook.

16. The method as claimed in claim 13, further comprising:
changing the restoration bit for the phonebook to a bit value corresponding to phonebook registration when restoration of the phonebook is requested; and
restoring the phonebook to a phonebook list.

17. The method as claimed in claim 13, further comprising:
displaying at least one phonebook deleted from the phonebook list when a phonebook restoration is requested, and receiving a selection command designating a phonebook to be restored;
changing a restoration bit for the phonebook selected to be restored to a bit value corresponding to phonebook registration; and
registering the phonebook in the phonebook list.

18. The method as claimed in claim 13, further comprising:
receiving data corresponding to contents to be stored and storing the data in the phonebook, when storage of the phonebook is requested;
changing a restoration bit for the phonebook to a bit value corresponding to phonebook registration; and
registering the phonebook in the phonebook list.

19. The method as claimed in claim 13, further comprising:
checking a storage space allocated to the phonebook list when storage of the phonebook is requested, and displaying phonebooks deleted from the phonebook list when there is substantially no empty storage space;
receiving data corresponding to contents to be stored, and storing the data in a phonebook selected from the displayed deleted phonebooks;
changing a restoration bit for the phonebook to a bit value corresponding to phonebook registration; and
registering the phonebook in the phonebook list.
